(19) United States
(12) Patent Application Publication
(10) Pub. No.: US 2018/0339478 A1
(43) Pub. Date: Nov. 29, 2018

(54) UPPER WITH 3-DIMENTIONAL POLYURETHANE PATTERN, METHOD FOR MANUFACTURING THE SAME AND SHOE PRODUCED BY THE SAME

(71) Applicant: ISOTECH HOLDING CORPORATION LLC, Dover, DE (US)

(72) Inventor: Yu-Hsien LEE, Hsinchu City (TW)

(21) Appl. No.: 15/605,476

(22) Filed: May 25, 2017

(51) Int. Cl. B29D 35/12; B29C 67/00; B33Y 10/00; B33Y 30/00; B33Y 80/00; A43D 8/22; A43B 3/00; A43B 23/02

(52) U.S. Cl. CPC B29D 35/126; B29C 67/0059; B33Y 10/00; B33Y 30/00; B29L 2031/505; A43D 8/22; A43B 3/0078; A43B 23/0215; A43B 23/0245; B33Y 80/00

(57) ABSTRACT

An upper with 3-dimensional (3D) polyurethane (PU) patterns, a method for manufacturing the same and a shoe produced by the same are revealed. First provide a semi-finished upper. Then provide at least one 3D printer and use PU as 3D printing material for printing at least one PU decorative unit on surface of the semi-finished upper. Next cure the PU decorative unit to get an upper with 3D PU patterns. The upper is used to produce a shoe. Thereby the variety of the shoe is increased and the cost of molds used in the conventional shoe making process is saved.

### BACKGROUND OF THE INVENTION

The present invention relates to an upper with 3-dimensional (3D) polyurethane (PU) patterns, a method for manufacturing the same and a shoe produced by the same, especially to an upper with 3D polyurethane PU patterns, a method for manufacturing the same and a shoe produced by the same in which 3D printing materials are used to form at least one PU decorative unit on surface of a semi-finished upper by 3D printing so as to make the upper and the shoe produced by the upper have different types of 3D decorative patterns.

3D printing and its applications now are getting popular and hot in a variety of fields. The related prior arts include U.S. Pat. No. 9,538,738, U.S. Pat. No. 9,522,522, U.S. Pat. No. 9,460,557, U.S. Pat. No. 9,453,142, etc. Leading athletic footwear producers like NIKE, ADIDAS, or Reebok have applied 3D printing in making shoes. The most important thing is cost-saving. For example, a shoe prototype is created by 12 shoemakers working for 4-6 weeks in the past. Only two shoemakers are needed while using 3D printing to make shoes. The 3D printing is not only labor-saving but also time-saving compared with general shoe production line.

Although 3D printing has already been applied to shoe making, most of the shoes produced are custom-made shoes including high heels or special shoes for people with special needs. The 3D printing technology is not mature enough for mass production of general inexpensive shoes such as running shoes, sport shoes, etc in consideration of a plurality of factors including 3D printing material, 3D printing operation, mass production speed, shoe selection (related to the exercise intensity), production cost, market competitiveness, etc.

In the 3D printing field for making general inexpensive sport shoes, there is room for improvement and a need to provide a novel design of shoes that balances among multiple factors including 3D printing material, 3D printing operation, mass production speed, shoe selection (related to the exercise intensity), production cost, and market competitiveness.

### SUMMARY OF THE INVENTION

Therefore it is a primary object of the present invention to provide an upper with 3D PU patterns, a method for manufacturing the same and a shoe produced by the same that not only increase variety of the decorative patterns on the upper but also improve process efficiency as well as market competitiveness of the upper.

In order to achieve the above object, a method for manufacturing an upper with 3D PU patterns according to the present invention includes the following steps. First provide a semi-finished upper with preset shape. Then provide at least one 3D printer and use PU as 3D printing material. The PU is come out of a print head of the 3D printer for performing 3D printing. Thus form at least one PU decorative unit on surface of the semi-finished upper by the above 3D printing. The PU decorative unit can be used to form various types of decorative patterns according to the user's design. Next cure the PU decorative unit to get an upper with 3D PU patterns.

The PU used as 3D printing material in the present invention includes two-component PU, moisture curable one component PU, and thermoplastic PU (TPU). The two-component PU consists of a first liquid component with low chemical reactivity and a second liquid component. The two liquid components are mixed before use. The moisture curable one component PU is firstly printed by 3D printing and then curing is carried out by utilizing moisture present in the air. TPU is heated to melt and then the melted TPU is come out of a print head of the 3D printer for performing printing.

While using the two-component PU as the 3D printing material, the first liquid component (such as polycyanate esters) and the second liquid component (such as polyols) are just mixed before use. For example, the first liquid component and the second liquid component are delivered to a chamber located before the print head (nozzle) of the 3D printer respectively to be mixed evenly therein. Then the mixture is come out of the print head to be printed on the surface of the semi-finished upper before curing.

The print head of the 3D printer has different sizes. The print head with a suitable size is selected for performing printing during the printing process to improve working efficiency of the 3D printing.

The semi-finished upper is flattened on a working table of the 3D printer. Thus PU can be printed on the surface of the semi-finished upper by the print head of the 3D printer quickly.

The semi-finished upper is produced directly by 3D printing of the 3D printer. Thus the cost of the upper mold and the cost of the following deburring are saved compared with the conventional shoe making process.

The semi-finished upper is integrally connected to the whole/or a part of a sole including an insole, a midsole, a outsole and their combinations by certain processes so as to form a semi-finished shoe. Then the semi-finished shoe is fit on a rotatable jig so that the semi-finished shoe can be rotated relative to the print head of the 3D printer. Thereby the PU is printed on the surface of the semi-finished shoe by the print head quickly.

The semi-finished upper is integrally connected to a sole including an insole, a midsole and an outsole to form a semi-finished shoe with preset shape. At least one groove is arranged at a bottom surface of the outsole. Thereby the PU is printed on the surface as well as in the groove of the upper of the semi-finished shoe by the print head of the 3D printer. At least one PU decorative unit is formed on the surface of the upper of the shoe and on the bottom surface of the outsole respectively.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing a print head of a 3D printer that is printing on surface of a semi-finished upper of an embodiment according to the present invention;

FIG. 2 is a perspective view showing the semi-finished upper of the embodiment in FIG. 1 after 3D printing according to the present invention;

FIG. 3 is an explosive view showing the semi-finished upper of the embodiment in FIG. 2 being connected to a sole according to the present invention;

FIG. 4 is a perspective view of a shoe after the embodiment in FIG. 3 being assembled according to the present invention;

FIG. 5 is an explosive view showing a semi-finished upper of an embodiment being connected to a sole (midsole) according to the present invention;

FIG. 6 is a schematic drawing showing a semi-finished shoe with the embodiment in FIG. 5 according to the present invention;

FIG. 7 is a schematic drawing showing a side view of the embodiment in FIG. 6 during 3D printing according to the present invention;

FIG. 8 is a schematic drawing showing the semi-finished shoe of the embodiment in FIG. 7 after 3D printing according to the present invention;

FIG. 9 is an explosive view showing the semi-finished shoe of the embodiment in FIG. 8 being connected to a sole (outsole) according to the present invention;

FIG. 10 is a perspective view of the semi-finished shoe of the embodiment in FIG. 9 being assembled according to the present invention;

FIG. 11 is an explosive view of a semi-finished upper of an embodiment being connected to a midsole and an outsole according to the present invention;

FIG. 12 is a perspective view of the semi-finished shoe of the embodiment in FIG. 11 being assembled according to the present invention;

FIG. 13 is a schematic drawing showing a side view of the embodiment in FIG. 12 during 3D printing according to the present invention;

FIG. 14 is a schematic drawing showing a bottom surface of an outsole of the semi-finished shoe of the embodiment in FIG. 12 during 3D printing according to the present invention;

FIG. 15 is a schematic drawing showing a bottom surface of the outsole of the embodiment in FIG. 14 during 3D printing (bottom view) according to the present invention;

FIG. 16 is a perspective view of a shoe of the embodiment in FIG. 15 after 3D printing (top view) according to the present invention.

### DETAILED DESCRIPTION OF THE PREFERRED EMBODIMENTS

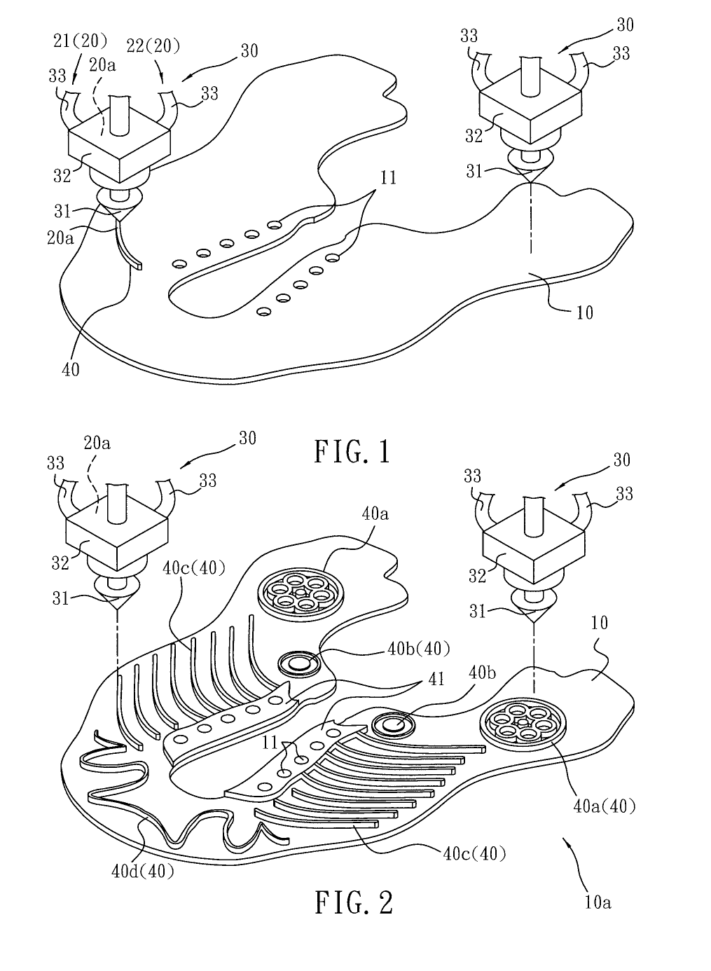

Refer to FIG. 1 and FIG. 2, the present invention provides an upper with 3-dimensional (3D) patterns made from polyurethane (PU), a method for manufacturing the same and a shoe produced by the same. As shown in FIG. 2, the upper includes a semi-finished upper 10 and at least one PU decorative unit 40. The semi-finished upper 10 is made from upper materials and having preset shapes. The PU decorative unit 40 is produced by a three-dimensional (3D) printer 30 and using PU 20 as 3D printing material. The PU 20 is come out of a print head 31 of the 3D printer 30 to be printed on and integrally connected to surface of the semi-finished upper 10.

A method for manufacturing an upper with 3D PU patterns includes the following steps.

Step 1: providing a semi-finished upper 10. The semi-finished upper 10 can be, but not limited to, produced by conventional shoe making process. For example, synthetic leather made from PU, polyvinyl chloride (PVC) or their combinations is used as the upper material. Then a molding process is performed. First an upper mold is produced and then a prototype is obtained by casting with the upper mold. Next remove burrs from the prototype to get the semi-finished upper 10 with preset shape, as shown in FIG. 1. The semi-finished upper 10 may have different shapes or various numbers of eyelets 11 at different positions according to designers' requirements.

Step 2: providing at least one 3D printer 30 and using PU 20 as 3D printing material. The PU 20 consists of two-component PU, moisture curable one component PU, and thermoplastic PU (TPU). Now take the two-component PU as an example. A first liquid component 21 can be polycyanate esters with low chemical reactivity while a second liquid component 22 can be polyols. The two components 21, 22 are just mixed before use. As shown in FIG. 1, the first liquid component 21 and the second liquid component 22 are delivered to a chamber 32 located before the print head (or nozzle) 31 of the 3D printer 30 through pipelines 33 respectively to be mixed evenly therein. The mixing can be achieved by arrangement of a stirring mechanism (not shown in figure) in the chamber 32. Then the mixed two component PU 20a is come out of the print head 41 to be printed on surface of the semi-finished upper 10 by 3D printing before curing. The respective component of the 3D printer 30 such as the print head 31, the chamber 32 (or the stirring mechanism arranged therein), the pipelines 33 and their functions can be achieved by techniques available now.

Step 3: forming at least one PU decorative unit 40 on surface of the semi-finished upper 10 by 3D printing. The PU decorative unit 40 can be designed into various types according to preset patterns, such as embossed patterns 40a, 40b, embossed lines 40c, 40d, or the embossed pattern that increases the strength of the upper, etc. In FIG. 2, the embossed patterns 40a, 40b are formed around the eyelets 11 of the semi-finished upper 10. Thus the tearing strength of the eyelets 11 is improved.

Step 4: Cure the PU decorative unit 40 to get an upper 10a with 3D PU patterns, as shown in FIG. 2.

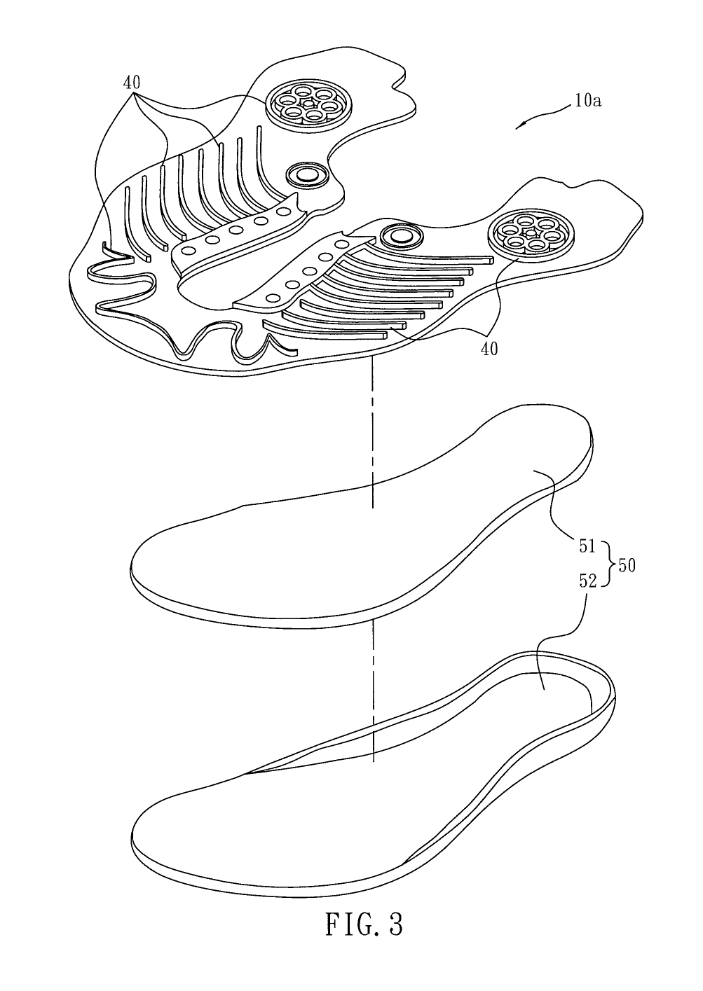

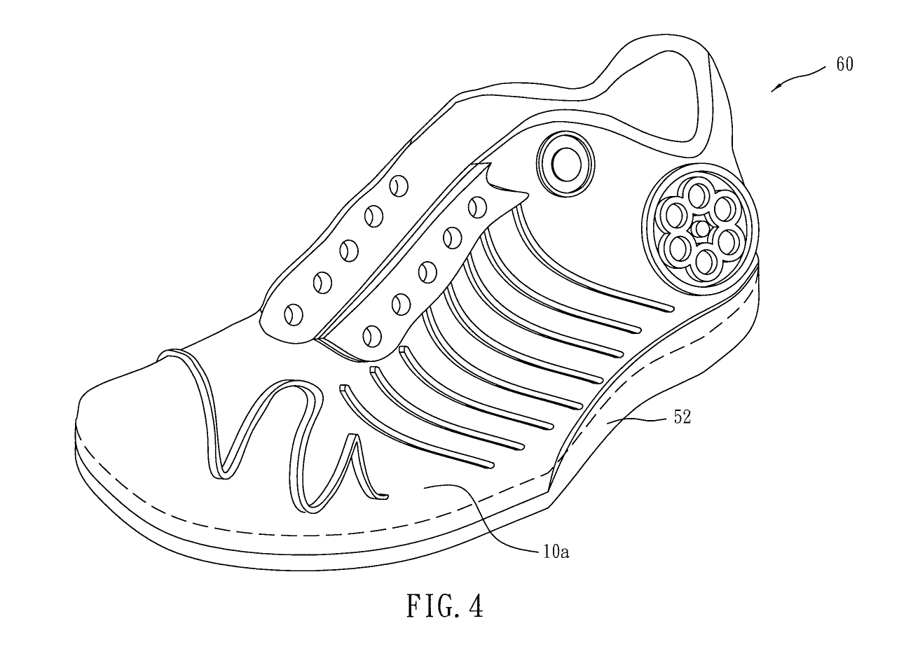

Moreover, the upper 10a obtained in the step S4 can be further processed. For example, a process for integrating the upper 10a with a sole 50 is performed as shown in FIG. 3. The sole 50 generally includes, but not limited to, an insole (not shown in figure), a midsole 51 and an outsole 52. Thus the assembly of a shoe 60 has been completed, as shown in FIG. 4. The competitiveness of the shoe 60 in the market is further improved.

The 3D printer 30 can be disposed with a plurality of print heads 31 having different sizes. As shown in FIG. 1 and FIG. 2, there are two print heads 31 that are designed to be moved independently or synchronously. Moreover, the print heads 31 with different sizes can be selected for forming respective PU decorative unit 40 by printing during the 3D printing process. Thereby working efficiency of each print head 31 is improved.

Refer to FIG. 1 and FIG. 2, the semi-finished upper 10 is flattened on a working table (not shown in figure) of the 3D printer 30 so that the printing material PU 20 can be printed on the surface of the semi-finished upper 10 by the print head 31 quickly.

Furthermore, for higher process efficiency of the upper 10a of the present invention, the semi-finished upper 10 in the step 1 can be further printed directly by the 3D printer 30. Refer to FIG. 1, the semi-finished upper 10 is printed by the print head 31 of the 3D printer 30 (refer to the print head 31 on the right side). Thus the cost of the upper mold and the cost of the following deburring are saved compared with the conventional shoe making process.

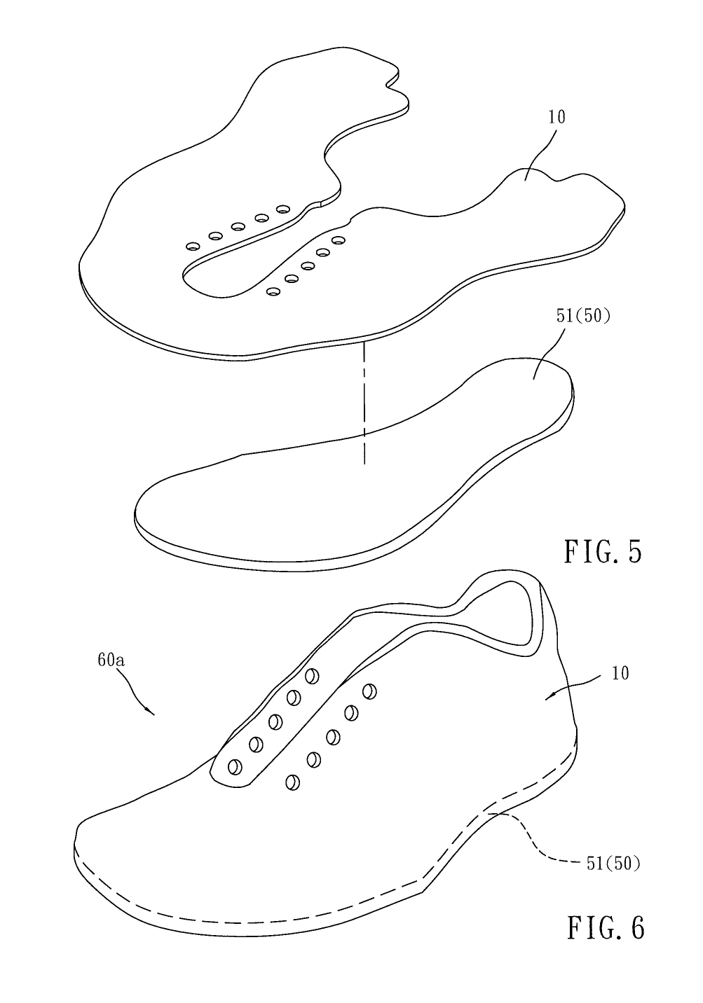

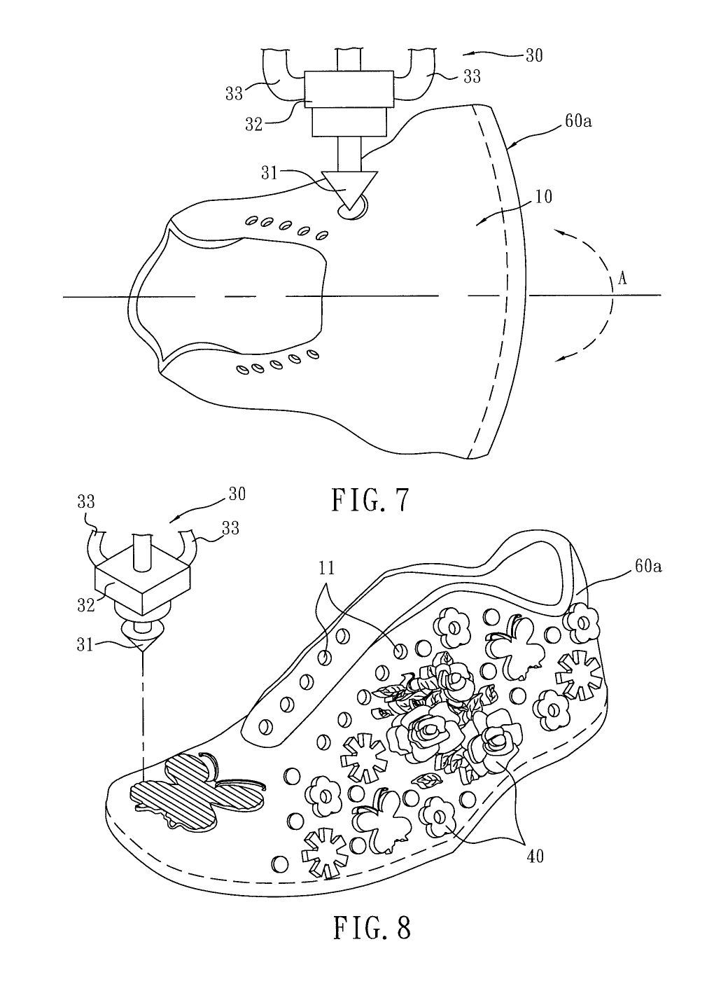

Refer to FIG. 5, the semi-finished upper 10 in the step 1 can be integrally connected to the whole/or a part of the sole 50 including an insole (not shown in figure), a midsole 51 and their combinations by certain processes (such as adhesive lamination). Thus a semi-finished shoe 60a with the semi-finished upper 10 is formed, as shown in FIG. 6. Then the semi-finished shoe 60a is fit on a rotatable jig or fixture (not shown in figure) with specific design so as to adjust the angle of the semi-finished shoe 60a relative to the print head 31 of the 3D printer 30, as the arrow A in FIG. 7 indicates. Thereby the print head 31 performs 3D printing on surface of the semi-finished upper 10 of the semi-finished shoe 60a, as shown in FIG. 7. And at least one PU decorative unit 40 made from the printing material PU 20 is formed on the surface of the semi-finished upper 10, as shown in FIG. 8.

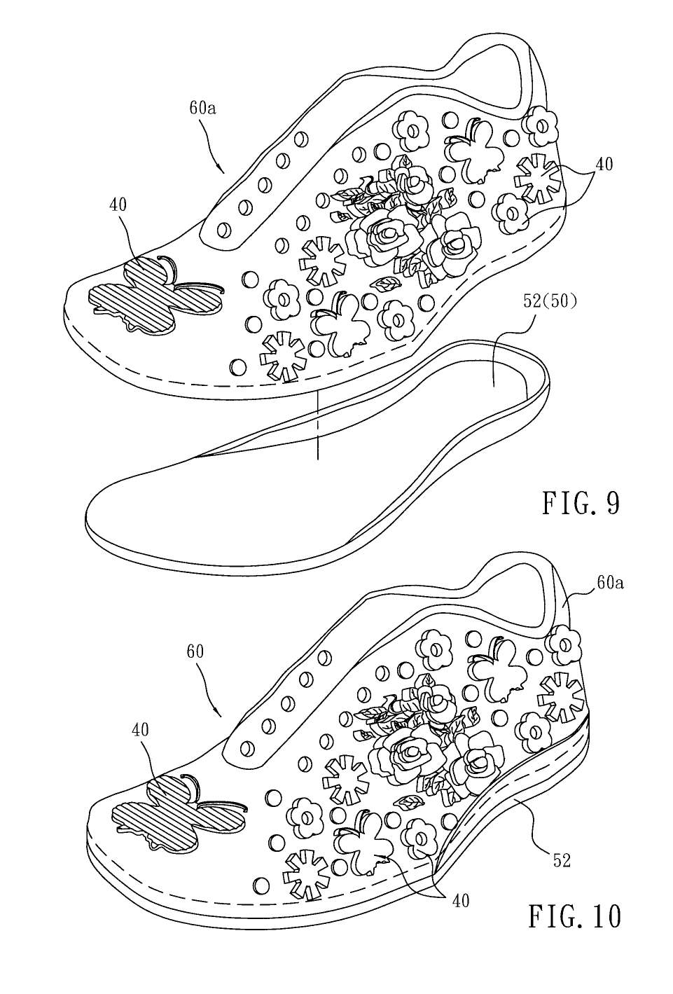

In addition, the semi-finished shoe 60a with at least one PU decorative unit 40 is treated by the following processing. For example, the semi-finished shoe 60a is integrally connected to the outsole 52 of the sole 50 to form the shoe 60, as shown in FIG. 9 and FIG. 10. The surface of the shoe 60 is disposed with at least one PU decorative unit 40 by printing so that the shoe 60 is more competitive than the conventional one on the market owing to its versatility.

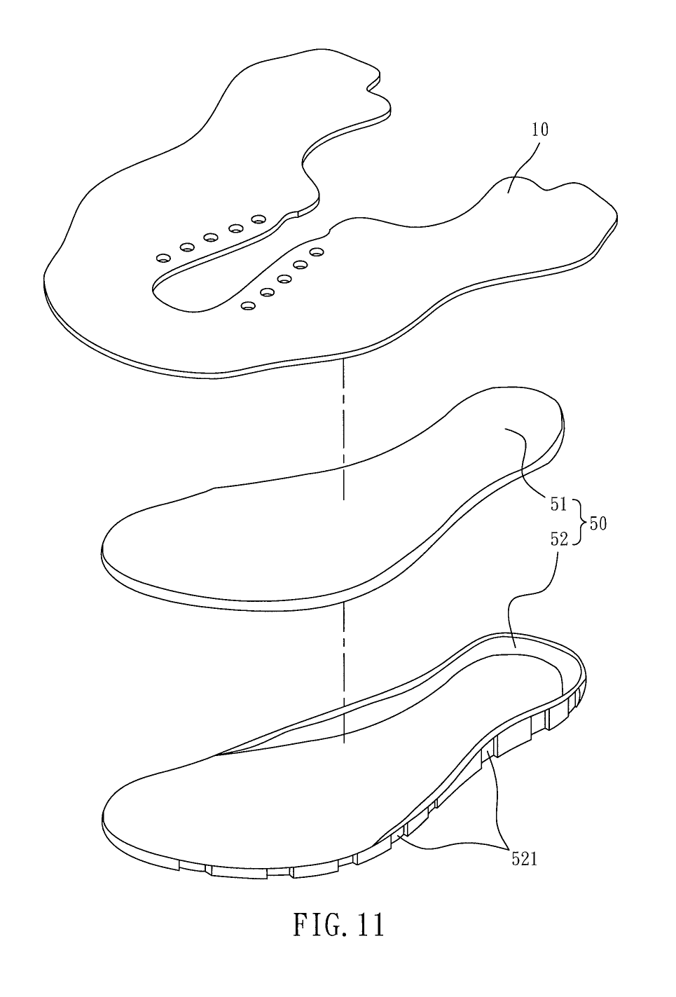

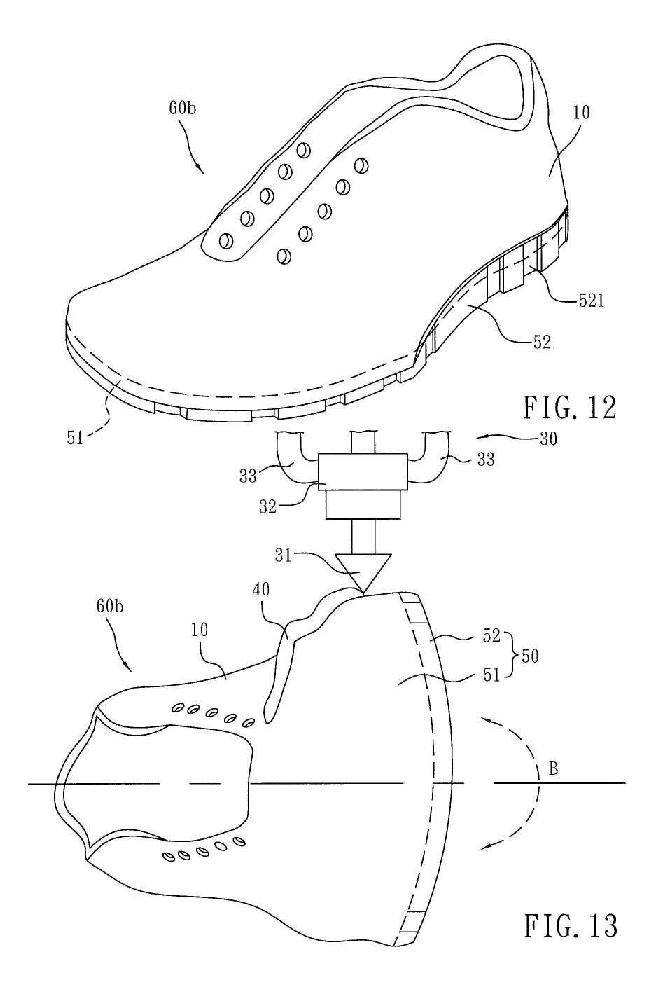

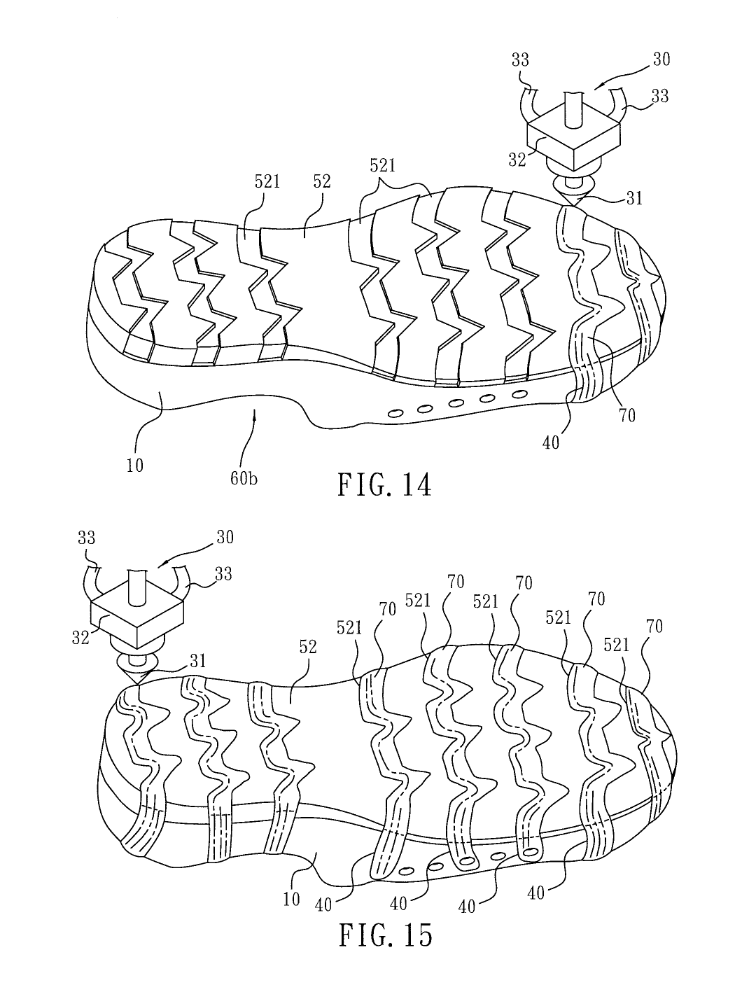

Refer to FIG. 11, the semi-finished upper 10 provided in the step 1 can be integrally connected to a sole 50 including an insole (not shown in figure), a midsole 51 and a outsole 52 by certain processes (such as adhesive lamination) first so as to form a semi-finished shoe 60b having preset shape and looking like a shoe, as shown in FIG. 12. At least one groove 521 is arranged at a bottom surface of the outsole 52 (including the bottom surface and the edges/sides extended upward). The shape of the groove 521 and its position on the bottom surface of the outsole 52 are not limited and able to be modified according to designers' needs. For example, a plurality of irregular transverse grooves 521 is set on the bottom surface 52 of the outsole 52, as shown in FIG. 13 and FIG. 14.

Then the semi-finished shoe 60b is fit on a rotatable jig or fixture (not shown in figure) with specific design. Thus the angle of the semi-finished shoe 60b relative to the print head 31 of the 3D printer 30 can be rotated and adjusted freely, as the arrow B in FIG. 13 indicates. Thereby the print head 31 performs 3D printing on the surface of the semi-finished upper 10 of the semi-finished shoe 60b to form at least one PU decorative unit 40, hereafter called the first PU decorative unit 40. The print head 31 further performs 3D printing on the bottom surface of the outsole 52 of the semi-finished shoe 60b to form at least one PU decorative unit 70 in each groove 521 on the bottom surface of the outsole 52, as shown in FIG. 14 and FIG. 15. The PU decorative unit 70 hereafter is called the second PU decorative unit 70. The second PU decorative unit 70 provides not only the decorative function but also the anti-slip function when a thickness/height of the second PU decorative unit 70 is a bit higher than (or projecting from) the bottom surface of the outsole 52.

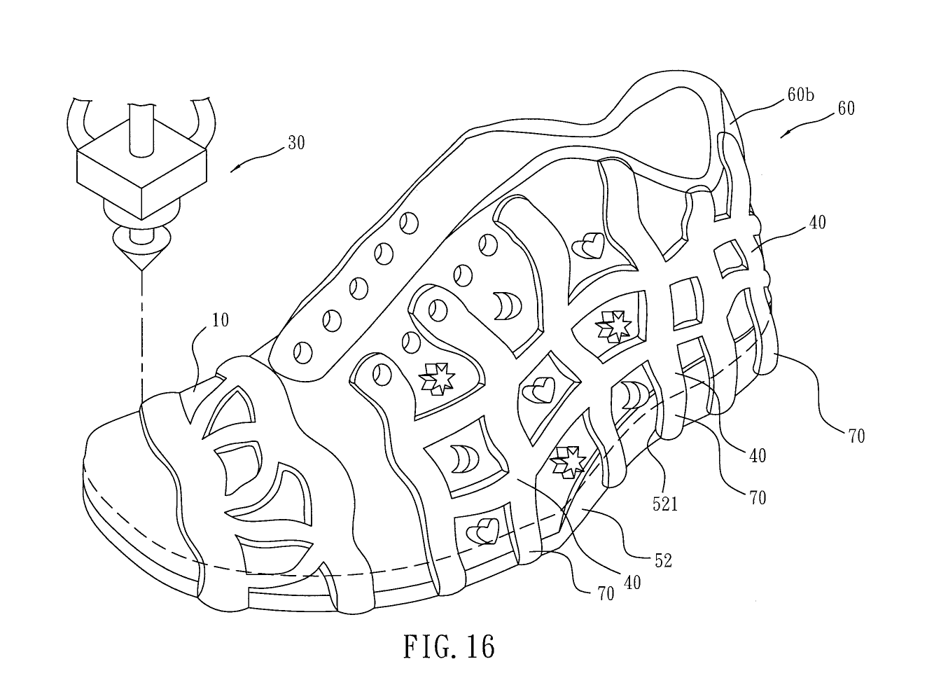

The 3D printing of the second PU decorative unit 70 and that of the first PU decorative unit 40 can be performed respectively or successively. The respective printing means all the first PU decorative units 40 are formed on the surface of the semi-finished upper 10 by the print head 31 firstly. Then the bottom surface of the outsole 52 of the semi-finished shoe 60b is rotated and adjusted to face the print head 31 for producing all the second PU decorative units 70 in the grooves 521 on the bottom surface of the outsole 52 by 3D printing. The first PU decorative units 40 and the second PU decorative units 70 are printed and formed separately. As to the successive printing, it means the print head 31 prints a part of the first PU decorative units 40 on the surface of the semi-finished upper 10 (or also the edge/side of the second PU decorative units 70), as shown in FIG. 13. Then the bottom surface of the outsole 52 of the semi-finished shoe 60b is rotated and adjusted to face the print head 31 for performing 3D printing on the bottom surface of the outsole 52 and producing a part of the second PU decorative units 70 successively, as shown in FIG. 14. Next the semi-finished shoe 60b is rotated and adjusted again to make the semi-finished upper 10 of the semi-finished shoe 60b face the pint head 31 for producing another part of the first PU decorative units 40 by 3D printing (back to FIG. 13). The above processes are carried out alternately and successively so as to complete printing of all the first PU decorative units 40 and the second PU decorative units 70. The 3D printing of the first PU decorative units 40 and that of the second PU decorative units 70 are performed alternately and successively along with the rotation and adjustment of the semi-finished shoe 60b. After completing the 3D printing, the first PU decorative units 40 and the second PU decorative units 70 are partially connected owing to the successive and alternate printing manner, as shown in FIG. 15 and FIG. 16. The structural strength of the shoe 60 is further enhanced due to partial connection between the first PU decorative units 40 and the second PU decorative units 70.

1. An upper with 3-dimensional (3D) polyurethane (PU) patterns comprising:
a semi-finished upper that is made from upper materials and having preset shapes; and
at least one PU decorative unit produced by using at least one 3D printer and polyurethane (PU) as 3D printing material; the PU is come out of a print head of the 3D printer to be printed on and integrally connected to surface of the semi-finished upper.

2. The device as claimed in claim 1, wherein the semi-finished upper is directly printed by the 3D printer; PU is used as 3D printing material and is come out of the print head of the 3D printer.

3. The device as claimed in claim 1, wherein the PU includes two-component PU, moisture curable one component PU, and thermoplastic PU (TPU).

4. The device as claimed in claim 1, wherein the PU used is the two-component PU; a first liquid component and a second liquid component of the two-component PU are delivered to a chamber located before the print head of the 3D printer respectively for being mixed evenly therein and then the two-component PU is come out of the print head before curing.

5. A shoe comprising the upper with 3D PU patterns as claimed in claim 1.

6. A method for manufacturing an upper with 3-dimensional (3D) polyurethane (PU) patterns comprising the steps of:
step 1: providing a semi-finished upper;
step 2: providing at least one 3D printer and using PU as 3D printing material;
step 2: forming at least one PU decorative unit on surface of the semi-finished upper by a print head of the 3D printer that performs 3D printing;
step 4: curing the PU decorative unit to get an upper with 3D PU patterns.

7. The method as claimed in claim 6, wherein the semi-finished upper provided in the step 1 is produced by the 3D printer; PU is used as 3D printing material and is come out of the print head of the 3D printer.

8. The method as claimed in claim 6, wherein the upper got in the step 4 is further processed and integrally connected to a sole to form a shoe.

9. The method as claimed in claim 6, wherein the semi-finished upper provided in the step 1 is further integrally connected to a part of a sole to form a semi-finished shoe with the semi-finished upper; then the semi-finished shoe is able to be rotated and adjusted relative to the print head of the 3D printer so that the PU decorative unit is formed by the print head of the 3D printer that performs 3D printing on the surface of the semi-finished upper.

10. The method as claimed in claim 6, wherein the semi-finished upper provided in the step 1 is further integrally connected to a sole to form a semi-finished shoe with preset shape; wherein at least one groove is arranged at a bottom surface of an outsole of the sole; then the semi-finished shoe is able to be rotated and adjusted relative to the print head of the 3D printer so that at least one first PU decorative unit is formed by the print head of the 3D printer that performs 3D printing on the surface of the semi-finished upper of the semi-finished shoe, and at least one second PU decorative unit is formed by the print head of the 3D printer that performs 3D printing in the groove on the bottom surface of the outsole of the semi-finished shoe.

11. The method as claimed in claim 10, wherein a thickness of the second PU decorative unit is higher than a thickness of the bottom surface of the outsole.

12. The method as claimed in claim 10, wherein 3D printing of the second PU decorative unit and 3D printing of the first PU decorative unit are carried out respectively or successively;
all the first PU decorative units are formed on the surface of the semi-finished upper by the print head of the 3D printer firstly and then the bottom surface of the outsole of the semi-finished shoe is rotated and adjusted to face the print head for producing all the second PU decorative units in the grooves respectively on the bottom surface of the outsole by 3D printing when the 3D printing of the second PU decorative unit and the 3D printing of the first PU decorative unit are carried out respectively; thereby the first PU decorative units and the second PU decorative units are printed and formed separately;
when the 3D printing of the second PU decorative unit and the 3D printing of the first PU decorative unit are carried out successively, a part of the first PU decorative units on the surface of the semi-finished upper is printed by the print head of the 3D printer firstly and then the bottom surface of the outsole of the semi-finished shoe is rotated and adjusted to face the print head for performing 3D printing on the bottom surface of the outsole and producing a part of the second PU decorative units successively by the print head; next the semi-finished upper of the semi-finished shoe is rotated and adjusted to face the print head so that the print head performs 3D printing on the surface of the semi-finished upper for producing another part of the first PU decorative units; thereby the 3D printing of the second PU decorative unit and the 3D printing of the first PU decorative unit are carried out alternately and successively by rotation and adjustment of the semi-finished shoe; the first PU decorative units and the second PU decorative units are partially connected after completing the 3D printing.

13. A shoe produced by the method for manufacturing an upper with 3D PU patterns as claimed in claim 6.
